(19) United States
(12) Patent Application Publication
(10) Pub. No.: US 2003/0066217 A1
(43) Pub. Date: Apr. 10, 2003

(54) Calendar frame

(76) Inventor: Michaela Graham, Atlanta, GA (US)

Correspondence Address: Joseph G. Mitchell, ESQ., 4521 DERBY Lane, Smyrna, GA, 30082, US

(21) Appl. No.: 10/262,319

(22) Filed: Oct. 1, 2002

Related U.S. Application Data
(60) Provisional application No. 60/328,224, filed on Oct. 10, 2001.

(51) Int. Cl. G09D 3/04

(52) U.S. Cl. 40/120

(57) ABSTRACT

A calendar frame specifically designed, based on its specific dimensions, to hold a standard wall calendar and associated picture in one easy to view depiction. The calendar frame is designed to quickly allow the advancement of the next month and associated picture when the month changes. It provides a simple means to incorporate a standard calendar into the calendar frame and an uncomplicated method to secure the calendar frame to the wall.

### CROSS-REFERENCE TO RELATED APPLICATIONS

The Applicant filed a Provisional Patent Application for the invention in U.S. PTO 60/328,224 on Oct. 10, 2001 and claims such Provisional Patent Application as an earlier filed application.

### BACKGROUND OF THE INVENTION

1. Field of the Invention

The field of invention relates to a calendar frame. More particularly, the invention provides for an easy and economical means to present a standard wall calendar to the user using a frame to surround and hold said standard wall calendar.

2. Description of Prior Art

In the prior art, there are several frames and several means to hold a calendar in place.

U.S. Pat. Nos. 2,809,454, 4,212,124, and 4,976,055 depict frames that are used to mount a picture, sign or poster. The subject invention is designed to specifically hold a calendar and provide for an easy means to change the month of the calendar. The referred to prior art are not specifically employed to hold a standard wall calendar like the subject invention.

U.S. Pat. No. DES. 318,292 to Duncan depicts a calendar holder which is a design patent that has a gothic look. The subject invention is not designed to look gothic, so it's overall design is unique as compared to Duncan's design patent.

U.S. Pat. No. 4,423,562 to Nichols depicts a wall calendar and support means in which to write. The subject invention does not provide a support means in which to write and therefore allows for an easy means to change the month of the calendar, is less costly to manufacture and is believed to have an overall better appearance.

U.S. Pat. No. 5,316,342 to Almo depicts a calendar that is used particularly by children to display art on such calendar.

U.S. Pat. No. 6,345,456 to Bracken is a permanent calendar frame which can display both an artistic picture and a monthly calendar and which has two spaces, one for the picture and the second for the calendar, and such picture and calendar of the month are divided by a pivotal calendar retaining means.

Thus, the prior art is different from the subject invention. The present invention employs an easy means to change a calendar's picture and monthly calendar pages from month to month and presents a pleasing appearance to the user. It is specifically designed, in its specific dimensions, to retain a standard calendar and associated picture.

### SUMMARY OF THE INVENTION

Many individuals use a calendar to keep up with the days of the week. Often, such individuals tack the calendar to the wall. When changing the calendar to the next month, the tack is removed and reattached (along with the calendar) to the wall.

The purpose of this invention is to provide an easy and economical means for individuals to view a calendar by employing a frame designed specifically for such calendar.

The invention is a calendar frame to support a standard wall calendar. The invention comprises a frame, having a back portion and an open front. The calendar frame is attached to the wall with at least one nail or tack that goes through the calendar and hole in the back portion into the wall or by at least one hanger attached to the back portion which, in turn, attaches to the wall. The calendar is placed within the calendar frame and against the back portion. The calendar and calendar frame is then attached to the wall using at least one nail or tack that goes through the calendar and hole in the back portion into the wall or by at least one hanger attached to the back portion which, in turn, attaches to the wall.

The calendar frame is in the shape of a rectangle. It is specifically designed to hold and enclose a standard wall calendar. A standard wall calendar measures twenty-four (24) inches high and about twelve (12) inches wide. It has a picture portion located in the top portion of the wall calendar and a monthly calendar located in the bottom portion. The picture portion measures twelve (12) inches high and about twelve (12) inches wide. The monthly calendar portion also measures twelve (12) inches high and about twelve (12) inches wide. The standard wall calendar's width fits right up against the inside side portions of the calendar frame. The calendar frame measures twenty three (23) from the inside top portion to the inside bottom portion of such calendar frame. The calendar frame has a back portion that is attached to the side portions of the calendar frame. There is a groove that measures a quarter (¼) inch from the back portion to the top portion and bottom portion of the calendar frame such there is a space so that the wall calendar's bottom portion can fit within such groove. Thus, the calendar frame provides a perfect fit for a standard wall calendar.

One objective of this invention, then, is to provide a means to present a calendar to the user that is pleasing to the eye.

Another objective of the invention is to make it easy to use.

A further objective of the invention is to provide an easy means to make it and build it so that it is economical to purchase for the consuming public.

Yet another objective of the invention is to provide a device so that the user's environment and room looks better overall.

Another objective of the invention is to provide a calendar frame that allows a standard wall calendar to fit perfectly within such calendar frame.

Another objective of the invention is to allow for a better means to attach a standard wall calendar to a wall.

### BRIEF DESCRIPTION OF THE DRAWINGS

The invention will be better understood based on the following detailed description. Such description makes reference to the annexed drawing wherein:

FIG. 1 shows a perspective view of the invention

### DESCRIPTION OF THE PREFERRED EMBODIMENT

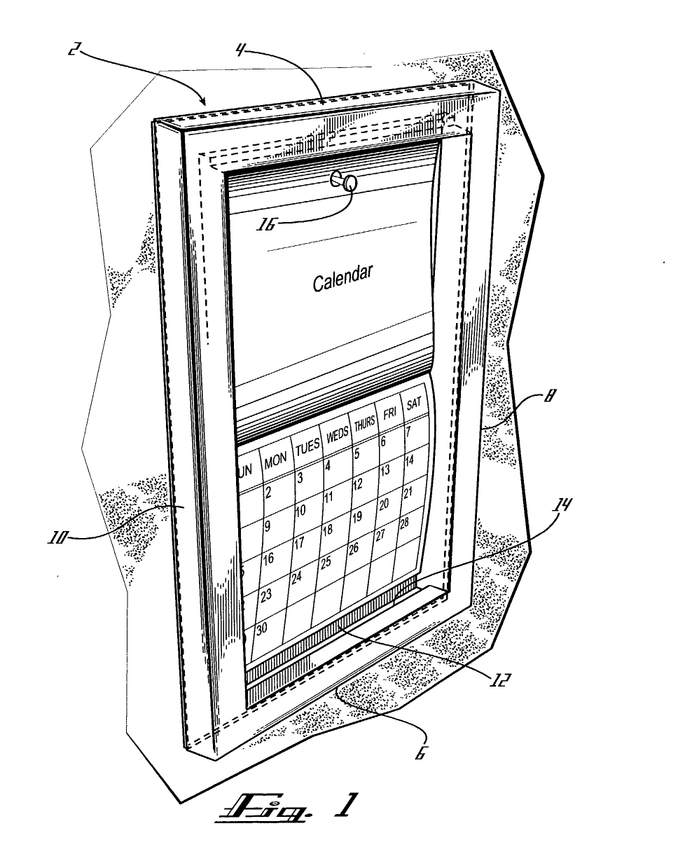

With reference now to the drawing, and in particular FIG. 1, the calendar frame 2 embodies the principles and concepts of the present invention.

With reference to FIG. 1, the calendar frame 2 provides a top portion 4 and bottom portion 6. The calendar frame also consists of two sides, 8 and 10, respectively. The top portion 4, bottom portion 6, and two sides, 8 and 10, are connected so as to form a rectangle.

A back portion 12 is attached to the back of the sides, 8 and 10. Connecting the sides, 8 and 10, to the back portion 12 causes the formation of a gap 14 such that a calendar can easily slide between the bottom portion 6 and sides, 8 and 10.

While the measurement is representative only, the gap 14 is an opening approximately a quarter inch as measured from the bottom portion 6 to the back portion 12.

An opening is provided (between the top portion 4, the bottom portion 6 and the sides, 8 and 10) for the viewing of a calendar. The preferred measurement for the opening should be twenty-three (23) inches from the inside of the top portion 4 to the inside of the bottom portion 6.

The sides, 8 and 10, are twelve (12) inches apart as measured from the inside of the both of the such sides, 8 and 10.

The preferred embodiment has a nail or tack 16 placed through the calendar and a hole in the back portion 12 so as to mount a standard wall calendar and calendar frame on the wall.

Alternatively, although not depicted in the FIG. 1, the calendar frame can be mounted by using at least one hanger mounted to the back portion 12, instead of employing the nail or tack 16.

With reference to FIG. 1, a user would place a calendar within the opening provided between the top portion 4, bottom portion 6, and respective sides, 8 and 10. Or, the user can slide the calendar in the groove formed between the bottom portion 6 of the calendar frame and back portion 12. The calendar is viewed in the opening in the calendar frame. The calendar would be placed against the back portion 12. A nail or tack 16 would then hold the calendar and calendar frame 2 to a wall.

With respect to the above description then, it is to be realized that the optimum dimensional relationships for the invention to include variations in size, materials, shape, form, function and manner of operation, assembly and use, are deemed readily apparent and obvious to one skilled in the art, and all equivalent relationships to those skilled in the art, and all equivalent relationships to those illustrated in the drawing and described in the specification are intended to be encompassed by the present invention.

Thus, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by letters patent of the United States is as follows:

1. A calendar frame, comprising:
a top portion;
a bottom portion;
a back portion;
a left side;
a right side;
said top portion, bottom portion, left side, and right side are connected to form a rectangle;
said back portion is connected to said left side and said right side such that there is an gap formed between said back portion and said top portion and said bottom portion;
said left side and said right side are twelve inches apart as measured from the inside of said left side and the inside of said right side; and
said top portion and said bottom portion are twenty-three inches apart as measured from the inside of said top portion to the inside of said bottom portion.

2. The device of claim 1, wherein the gap formed between said back portion and said top portion and bottom portion is one quarter inch as measured from said back portion to said top portion and bottom portion.

3. The device of claim 1, further comprising a means to connect said back portion to a wall.

4. The device of claim 3, wherein said connecting means is at least one hole in said back portion whereby a tack is placed through said hole to attach a calendar and said back portion to a wall.

5. The device of claim 3, wherein said connecting means is a plurality of nails and a wire connected to said back portion.

6. A calendar frame, comprising:
a top portion;
a bottom portion;
a back portion having at least one hole therein;
a left side;
a right side;
said top portion, bottom portion, left side, and right side are connected to form a rectangle;
said back portion is connected to said left side and said right side such that there is a gap formed between said back portion and said top portion and said bottom portion, and the gap is a quarter inch as measured from said back portion to said top portion and said bottom portion;
said left side and said right side are twelve inches apart as measured from the inside of said left side and the inside of said right side; and
said top portion and said bottom portion are twenty-three inches apart as measured from the inside of said top portion to the inside of said bottom portion.

7. The device of claim 6, wherein at least one hole is in said back portion whereby a tack is placed through said hole to attach a calendar and said back portion to a wall.
